(19) United States
(12) Patent Application Publication
(10) Pub. No.: US 2007/0059613 A1
(43) Pub. Date: Mar. 15, 2007

(54) REPOSITIONABLE PHOTO CARD

(76) Inventors: Jonathan P. Kitchin, Leander, TX (US); David N. Hering, Minneapolis, MN (US)

Correspondence Address: 3M INNOVATIVE PROPERTIES COMPANY, PO BOX 33427, ST. PAUL, MN, 55133-3427, US

(21) Appl. No.: 11/379,459

(22) Filed: Apr. 20, 2006

Related U.S. Application Data
(63) Continuation-in-part of application No. 11/271,274, filed on Nov. 12, 2005.
Application No. 11/271,274 is a continuation-in-part of application No. 11/227,549, filed on Sep. 15, 2005.

(51) Int. Cl. G03C 3/00

(52) U.S. Cl. 430/14

(57) ABSTRACT

The invention provides a repositionable photo card having a substrate comprising a base sheet having opposing first and second surfaces and an image receptive coating disposed on the first surface of the base sheet; and a repositionable adhesive disposed on the second surface of the base sheet. The substrate has been imaged with a digital printer such that the photo card comprises a text region and a photo region.

### CROSS REFERENCE TO RELATED APPLICATION

This application is a continuation in part of U.S. patent application Ser. No. 11/271,274 filed on Nov. 12, 2005, which is a continuation in part of U.S. patent application Ser. No. 11/227,549, filed Sep. 15, 2005. This application is also related to U.S. patent application Ser. No. 11/271,219 filed Nov. 12, 2005, which is a continuation in part of U.S. patent application Ser. No. 11/227,604 filed Sep. 15, 2005.

### FIELD OF INVENTION

The present invention pertains to a repositionable photo card that is particularly suited for use with digital photography and photo handling software. In particular, the present invention pertains to a photo card that can be readily imaged using a digital printer to create cards, that can be adhesively attached to a substrate for display and viewing.

### BACKGROUND

The use of digital cameras has increased in recent years. For example, in digital photography, the consumer can capture the desired images using the digital camera, view the images almost instantaneously on the camera screen, and at a later time select which image, if any, should be printed for display and viewing. Thus with digital photography, the photographer has the ability to select the most desirable images from a repertoire of stored images. In contrast, in traditional photography, most consumers take photos of the intended image, which is captured on the camera film. The film is taken to a photo-processing lab, which in turn generates a hard copy of the photographs. Because there is no ability to preview the photos, the consumer would receive all the pictures and consequently pay for all the pictures, whether or not she wanted all of the photos.

There are various software applications commercially available today that integrates digital images with text to create a personalized photo cards. An example of such software is Hewlett Packard Design Studio Software. Exemplary photo cards include holiday greetings cards, which typically include a photo section accompanied by a greetings text, such as, e.g., “Happy Holidays from Our Family”. Other photo cards include graduation announcements, birth announcements, and wedding invitations, just to name a few. With the availability of personal computers and digital printers, versatility of computer software, and a consumer's desire to personalize a message, photo cards have become an accepted communication tool. The current photo cards, however, are usually displayed with the use of a mechanical attachment device. For example, if the consumer desires to display a holiday greeting photo card on her refrigerator door, she most likely would use magnets or clips to attach the photo card.

What is needed is a product solution that allows the consumer to have versatility in making and displaying the photo card.

### SUMMARY

The present invention relates to a photo card that is intended as a consumable product. The photo card includes a base sheet, a repositionable adhesive, and a liner to allow for easy print to display of the image. With the infrastructure available for creating, electronically saving, and printing digital photos, the inventive photo card is especially useful for communicating special occasions or events. The photo card can also be displayed on any horizontal or vertical surface that the repositionable adhesive can be adhered to, such as, e.g., refrigerators (without the need for using magnets), wood or plastic surfaces (without the need for using additional tape), fabrics, walls, and windows. The repositionable adhesive is selected to provide good adhesion to the intended surface and yet will not leave adhesive residue once the photo card has been removed.

The present invention relates to a repositionable photo card that gives the user the ease of creating a personalized card and simplicity in displaying the imaged card. In one aspect, the present invention relates to a repositionable photo card comprising (i) a substrate comprising a base sheet having opposing first and second surfaces and an image receptive coating disposed on the first surface of the base sheet; and (ii) a repositionable adhesive disposed on the second surface of the base sheet, wherein the substrate has been imaged with a digital printer such that the photo card comprises a text region and a photo region.

In another aspect, the present invention relates to a repositionable photo card comprising (i) an imageable substrate comprising a base sheet having opposing first and second surfaces and an image receptive coating disposed on the first surface of the base sheet; and (ii) a repositionable adhesive disposed on the second surface of the base sheet, wherein the photo card comprises a text region and a photo region that have been chosen and printed from a photo handling software template stored in a central processing unit, the software receiving bit mapped images and allowing for selection and manipulation of the text region and the photo region. As used herein, the term “manipulate” generally means the ability to edit the text or photo regions. Editing of the text region would include, e.g., selecting the desired font and font size and rotating the text. Editing of the photo region would include, e.g., cropping or rotating the bit mapped image.

In yet another aspect, the present invention relates to a system for creating a repositionable photo card. The system comprises (i) a central processing unit including photo handling software that receives a bit-mapped image; (ii) a repositionable photo card, the card comprising an imageable substrate comprising a base sheet having opposing first and second surfaces and an image receptive coating disposed on the first surface of the base sheet; and a repositionable adhesive disposed on the second surface of the base sheet; and (iii) a printer in communication with the central processing unit, the printer capable of printing at least a portion of the bit-mapped image on the imageable substrate. In another embodiment, the photo handling software further generates text.

In yet another aspect, the present invention relates to a method of making a repositionable photo card as further described in detail below. The invention also provides a kit for producing personalized photo card. The kit comprises (i) a photo handling software application capable of receiving a bit mapped image; (ii) a repositionable photo card comprising an imageable substrate comprising a base sheet having opposing first and second surfaces, an image receptive coating disposed on the first surface of the base sheet and a repositionable adhesive disposed on the second surface of the base sheet; and envelopes for containing the repositionable photo card.

As used herein, the term “photo region” means that portion of the imaged photo card that contains bit mapped images that constitute a picture. The term “text region” means that portion of the imaged photo card that contains indicia. The term “graphics region means that portion of the imaged photo card that provides decorative embellishments. An imaged photo card is one that has been processed through a digital printer such that photo, text, and optionally graphics appear on the card.

### BRIEF DESCRIPTION OF THE DRAWINGS

The invention can be further described with reference to the following figures, wherein:

FIG. 1 is a schematic cross-sectional view of one embodiment of the present invention;

FIG. 2 is a plan view of a back side of an embodiment of the present invention; and

FIG. 3 is a plan view of a front side of an embodiment of the present invention.

These figures are idealized, are not drawn to scale, and are intended for illustrative purposes only.

### DETAILED DESCRIPTION

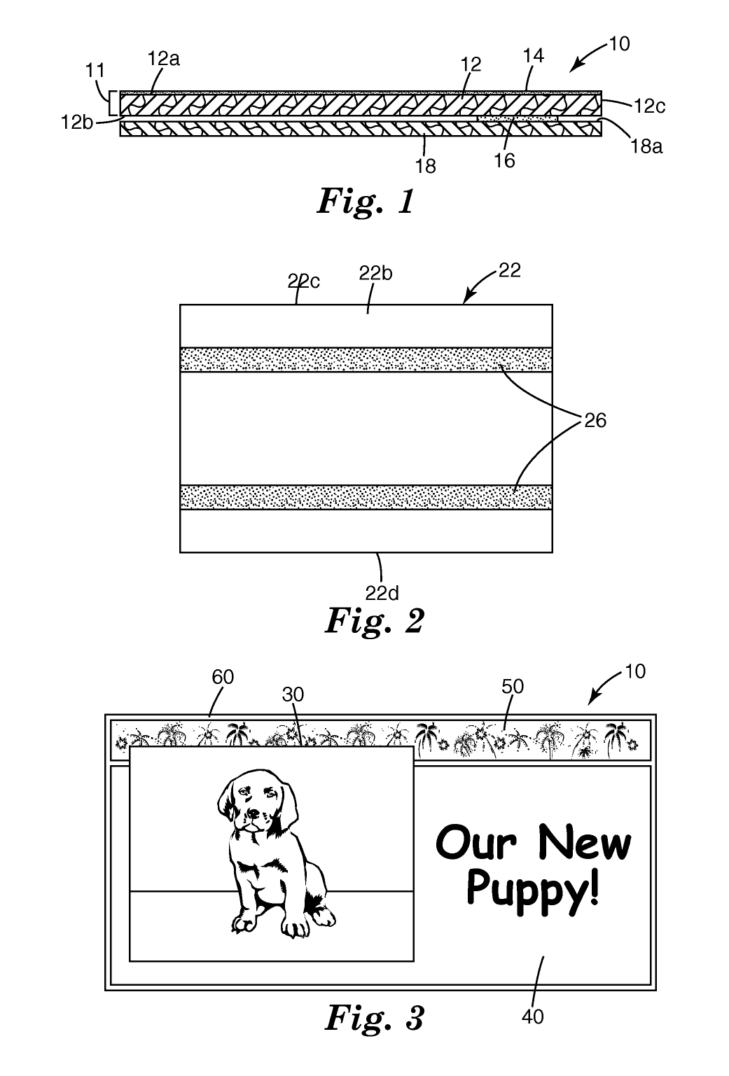

FIG. 1 shows a cross-sectional view of photo card 10. The photo card includes imageable substrate 11 having base sheet 12 and image receptive coating 14. The base sheet has opposing first surface 12a and second surface 12b. The image receptive coating is disposed on and covers substantially the entire first surface of the base sheet. Repositionable adhesive 16 is disposed on the second surface of the base sheet. In one embodiment, the repositionable adhesive does not cover the entire surface area of the second surface. In another embodiment, the repositionable adhesive is coextensive with the second surface of the base sheet. Optional liner 18 may or may not be substantially coextensive with the base sheet. In one embodiment, the liner includes a release coating disposed on major surface 18a so that the release coating is in direct contact with the repositionable adhesive. If desired, the opposing surface of surface 18a may be printed with indicia.

While the repositionable adhesive can be placed anywhere on the second side of the base sheet, in one embodiment, the adhesive is in the form of at least one stripe that is offset from and substantially parallel to edge 12c. In another embodiment, repositionable adhesive is disposed on the base sheet such that the leading edge of the sheet, as it enters a printer having a primary feed wheel, is adhesively attached to the liner at the point the primary feed wheel contacts the sheet.

FIG. 2 is a plan view of the backside of another inventive embodiment showing second surface 22b of base sheet 22, the base sheet having two opposing substantially parallel edges 22c and 22d. Offset from the edges are two substantially parallel repositionable adhesive stripes 26. Other stripe configurations and different number of stripes can be used. A 4 inch by 8 inch photo card would typically include two stripes of adhesive. The adhesive can also be disposed immediately next to the edge, if desired. Instead of using stripes of adhesive, other patterns can be used, such as islands or dots of adhesives. The adhesive can be disposed on the second surface so as to leave at least one edge of the photo card free of adhesive. Such an adhesive free edge product construction allows for easy removal of the liner before attaching to a surface and easy removal of the photo card after it has been applied to the display surface. The surface area of the second surface that needs to be covered with the adhesive depends upon, among other factors, the size of the photo card, the repositionable adhesive used, and the intended display mode and location.

FIG. 3 shows a plan view of a front side of an imaged photo card 10. The card includes photo region 30, text region 40, optional graphics region 50, and optional border 60. The border can be considered as part of the graphics region. It is within the scope of the present invention to have multiple photo, text, or graphic regions. Furthermore, the specific location of the photo, text, and graphics region can vary widely.

The present invention further provides a system for creating a personalized photo card. For example, the photo card can be personalized for a specific event or for specific holidays, or simply for a special moment. The system includes the use of a central processing unit (CPU), such as a computer, that includes photo handling software. The software is capable of receiving bit mapped images, e.g., digital photos stored in the CPU's memory, received via electronic mail, or downloaded from an internet site just to name a few sources. The system includes the repositionable photo card of the present invention. The system further includes a printer in communication with the CPU and capable of printing at least the bit mapped image on a portion of the repositionable photo card. In one approach to creating the personalized photo card, the photo handling software provides a plurality of different templates that a user can select. The template typically contains a region for receiving bit mapped images, a text region, and a graphics region. The photo and text regions may be manipulated. When using a template, the user selects the desired template, selects the desired bit mapped image to insert into the photo region of the template, and adds text that he wants to accompany the image. In another approach for creating the personalized photo card, a user can create his or her own template with a photo region, a text region, and optionally a graphics region.

The present invention further provides a method of making a personalized photo card. The method includes the steps of (i) providing a digital image; (ii) providing a central processing unit including photo handling software that receives a bit-mapped image and generates text; (iii) providing a printer that is in communication with the central processing unit; providing a repositionable photo card, the card comprising an imageable substrate comprising a base sheet having opposing first and second surfaces, an image receptive coating disposed on the first surface of the base sheet and a repositionable adhesive disposed on the second surface of the base sheet; (iv) using the photo handling software to create a virtual image of the photo card, the virtual image comprising a text region and a photo region; and (v) printing the virtual image on the imageable substrate. As used herein, the term “virtual image” generally means an image as seen on the CPU's screen to preview the photo card appearance.

Now turning to the various components of the imageable substrate, the base sheet can be constructed from a variety of materials including, e.g., paper, plastic (including foams and non-wovens), and textiles (wovens). The term “plastic” generally means thermoplastic or thermoset polymers that can be made into films or sheets. The term “textiles” generally mean woven materials or fabrics of natural fibers, artificial fibers, or a combination thereof. In one embodiment, the base sheet has a basis weight of 180 gram/m² or less. In another embodiment, the base sheet has a basis weight of 150 gram/m² or less.

In one embodiment, the base sheet is less than 0.010 inch (0.25 mm) in thickness. In one embodiment, when paper is used, the paper is supplied in calendared form, and the image receptive coating is coated thereon. One suitable paper is 100# Text Lunar paper, commercially available from Domtar, Inc., Quebec, Canada. Other suitable paper includes those commercially available from paper manufacturers such as Schoeller and International Paper.

Suitable plastics would include, e.g., polyolefin, polyester, polystyrene, polyamide, polyurethane and copolymers thereof. These materials may optionally be compounded with white pigment, nanoparticles or vesicles to mimic the appearance of paper. Plastics further include single and multilayer film constructions of one or more polymer materials, including blends, composites, and copolymers. The plastic films may be chemically or mechanically (calendering, orienting) modified to mimic paper like performance with the added benefit of enhanced moisture and curl resistance, when compared to paper substrates.

The image receptive coating can be of any composition that adheres to the substrate and is suitable for digital printing, such as inkjet printing, color inkjet printing, laser printing, and dye or mass transfer printing. When the image receptive coating is an inkjet receptive coating, suitable coatings would include two general classes of compositions: (1) those that absorb ink by capillary action, commonly described as porous, microporous, or nanoporous coatings, which may include silica, mixed oxides, and hydroxides of aluminum, and (2) those that include a hydrophilic polymer that absorbs ink by swelling, which are commonly referred to as swellable polymer coatings.

Suitable porous, microporous, or nanoporous coatings include U.S. Pat. Nos. 6,502,935 (Barcock et al.) and U.S. Pat. No. 6,830,798 (Misuda et al.).

Suitable swellable polymer, ink receptive coatings are described in U.S. Pat. No. 5,134,198 (Stofko, Jr. et al.), and U.S. Pat. No. 5,389,723 (Iqbal et al.). In very brief summary, both patents describe semi-interpenetrating polymer networks. These networks are blends of polymers where at least one of the polymeric components is crosslinked after blending to form a continuous network throughout the bulk material, and through which the uncrosslinked polymeric components are intertwined in such a way as to form a macroscopically homogeneous composition. Another suitable image receptive coating is described in U.S. Pat. No. 6,806,310 (Kopolow et al.), which discloses copolymers of dimethylaminopropyl methacrylamide (DMAPMA) and hydroxyethyl methacrylate (HEMA). It is stated that substrates coated with these copolymers are capable of absorbing the solvents, e.g., water or organic solvents, of digital printing inks rapidly with dry times of less than one minute. Yet another suitable image receptive coating is described in US Patent Application Publication No. US 2005/0027068, which discloses terpolymer compositions of vinyl caprolactam, DMAPMA, and HEMA to coat substrates for use in computer printers.

Suitable repositionable adhesives are disclosed in U.S. Pat. No. 3,691,140 (Silver); U.S. Pat. No. 3,857,731 (Merrill et al.); U.S. Pat. No. 4,166,152 (Baker et al.); U.S. Pat. No. 4,495,318 (Howard); U.S. Pat. No. 5,045,569 (Delgado); U.S. Pat. No. 5,073,457 (Blackwell) and U.S. Pat. No. 5,571,617 (Cooprider et al.), U.S. Pat. No. 5,663,241 (Takamatsu et al.); U.S. Pat. No. 5,714,237 (Cooprider et al.); US RE 37,563 (Cooprider et al.); and U.S. Pat. No. 5,756,625 (Crandall et al.) and U.S. Pat. No. 5,824,748 (Kesti et al.), all incorporated by reference in their entirety. The repositionable adhesive can be solvent based, water based, or can be a solventless, hot melt adhesive.

The photo card of the present invention can be further characterized by two adhesion tests: adhesion to polyester (specifically polyethylene terephthalate), and (2) static angle test (SAT). Both are described below in detail.

The adhesion to polyester test is performed by laminating a 1.25 inch (32 mm) strip of plain polyester, product designation OR16 film from 3M Company, St. Paul, Minn., over the previously coated and dried sample of repositionable adhesive. The polyester is laminated to the adhesive by using a 2 kg rubber coated roller rolling at a rate of 12 inch/min (25.4 mm/min). Using a stress/strain gauge, such as one available from Instron Corp., the polyester film is pulled away from the adhesive at a 90° angle at a peel rate of 12 inch/min (305 mm/min). The peel force is recorded in grams/inch.

The SAT measures the ability of the photo card with its repositionable pressure sensitive adhesive to remain adhered on a standard test panel while being subjected to removal pressure at a specified peel angle under a constant load. The static angle test is one quantitative procedure for measuring detachment resistance of the photo card.

In performing static angle test, six photo card samples can be prepared using the following exemplary process. The samples are all the same size, 33 mm wide by 76 mm long. Each sample of photo card includes an adhesive stripe that is 18 mm wide by 33 mm long, where the long dimension of each adhesive stripe is positioned along the short dimension of, and at the top of, each photo card sample.

The test panel is a steel panel with a painted surface. Each sample is applied to the painted steel panel with the long dimension of the adhesive stripe horizontally oriented and located at the top of the photo card sample. Then, the sample is pressure adhered to the painted steel surface by two passes of an application roller with an application pressure of 1.5 pounds per square inch (77.6 mm of mercury).

The mounted sample is placed in a holder frame that is vertically oriented approximately perpendicular to a ground surface. The painted steel panel is held at a 30° downward angle relative to the vertically oriented frame. A 100 gram load is applied to the lower end of the photo card sample, proximate to the lower end of the holder frame. A timer is started upon application of the 100 gram load to measure how long the sample remains attached to the painted steel surface before the photo card sample detaches from the steel panel. The SAT usually runs to failure, i.e., until the sample actually detaches form the steel panel. The time to detachment is usually measured in seconds as the average of six results.

The photo card of the present invention has an adhesion to polyester value of 200 gram/inch (7.9 gram/mm) or less, preferably less than 160 gram/inch (6.3 gram/mm) or less, and a SAT value of 600 seconds or greater, preferably 1800 seconds or greater. In general, the lower the adhesion to polyester value, the easier it will be to remove the photo card from the substrate to which it has been attached. In general, the higher the SAT value, the more likely the photo card will remain adhered to the intended substrate once it has been applied.

The liner is used to protect the repositionable adhesive until application. The liner can be any paper or plastic sheet that bonds to the repositionable adhesive securely during storage and while passing through the feed mechanism of a printer. The liner releases cleanly and easily from the repositionable adhesive after printing the photo paper. The liner may be treated with a release coating to achieve the desired release performance. Suitable coatings include those that based on straight chain alkane derivatives, polydialkyl siloxane derivatives, or fluorocarbon derivatives. One exemplary release coating is described in U.S. Pat. No. 5,032,460 (Kanter et al.). The release coating will be applied on the liner, typically the entire surface area of the liner, to reach a dry coating weight of from 0.05 gram/ft² (0.54 gram/m²) to 0.1 gram/ft² (1.1 gram/m²). Suitable silicone-based release liners are commercially available from Loparex, Inc., Willowbrook, Ill.

In one exemplary process, the inventive photo card is made in a continuous process as follows. The image receptive coating is coated on the first side of the base sheet using conventional coating techniques, such as gravure coating or die coating. The coated base sheet passes through a drying unit, such as an oven. At a next station, to the second side of the base, the repositionable adhesive is applied in a desired pattern using conventional coating methods. Optionally, an additional primer coating may be interposed between the adhesive and the base sheet. The adhesive coated base sheet, whether or not primed, passes through a second drying unit. A liner is then laminated to the base sheet such that the liner contacts the repositionable adhesive and the second side of the base sheet to form the photo card. The photo card can be wound into roll form and or converted into the desired size for the photo card. The dry coating thicknesses of the image receptive coating and the repositionable adhesive should be sufficient to provide the desired product attributes, including features such as good print quality (good resolution of the image) and good bonding to a surface. In one embodiment, the dry coating thickness of the image receptive coating is 3 microns or greater and 30 microns or less.

Other methods of making the photo card can be used. For example, the image receptive coating and the repositionable adhesive can be simultaneously applied to the base sheet, followed by a liner attachment step. The repositionable adhesive can be applied to an intermediate surface, such as a transfer roll, and then transferred to the base sheet.

Although specific embodiments of the present invention have been shown and described, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

1. A repositionable photo card comprising:
a substrate comprising a base sheet having opposing first and second surfaces and an image receptive coating disposed on said first surface of said base sheet; and
a repositionable adhesive disposed on said second surface of said base sheet,
wherein said substrate has been imaged with a digital printer such that said photo card comprises a text region and a photo region.

2. A repositionable photo card comprising:
an imageable substrate comprising a base sheet having opposing first and second surfaces and an image receptive coating disposed on said first surface of said base sheet;
a repositionable adhesive disposed on said second surface of said base sheet,
wherein said photo card comprises a text region and a photo region that have been chosen and printed from a photo handling software template stored in a central processing unit, said software receiving bit mapped images and allowing for selection and manipulation of at least one of said text region and said photo region.

3. The repositionable photo card of claims 1 or 2 further comprising a graphic region.

4. The repositionable photo card of claims 1 or 2 further comprising a liner disposed on said repositionable adhesive.

5. The repositionable photo card of claim 4, wherein said liner is coextensive with said second surface of said base sheet.

6. The repositionable photo card of claims 1 or 2, wherein said repositionable adhesive is substantially coextensive with said second surface of said base sheet.

7. The repositionable photo card of claims 1 or 2, wherein said repositionable adhesive is not coextensive with said second surface of said base sheet.

8. The repositionable photo card of claims 1 or 2, wherein said base sheet has at least one edge and said repositionable adhesive is in the form of at least one stripe offset from and substantially parallel to said at least one edge.

9. The repositionable photo card of claims 1 or 2, wherein said photo card has an adhesion to polyester of less than about 200 gram/inch and a static angle testing adhesion value of greater than about 600 seconds.

10. The repositionable photo card of claims 1 or 2, wherein said photo card has an adhesion to polyester of less than about 160 gram/inch and a static angle testing adhesion value of greater than about 1800 seconds.

11. The repositionable photo card of claims 1 or 2, wherein said repositionable adhesive is a microsphere adhesive.

12. The repositionable photo card of claim 11, wherein reposition able adhesive comprises polyacrylate derivative.

13. The repositionable photo card of claims 1 or 2, wherein said image receptive coating is a porous coating comprising oxides or silicates.

14. The repositionable photo card of claims 1 or 2, wherein said image receptive coating comprises a matting agent and a swellable hydrophilic polymer.

15. The repositionable photo card of claims 1 or 2 further comprising a liner disposed on said repositionable adhesive, said liner not coextensive with said second surface of said base sheet.

16. The repositionable photo card of claims 1 or 2, wherein said imageable substrate has a gloss value at 60° of at least 25%.

17. A system for creating an imaged photo card, the system comprising:
a central processing unit including photo handling software that receives a bit-mapped image;
a repositionable photo card, said card comprising an imageable substrate comprising a base sheet having opposing first and second surfaces and an image receptive coating disposed on said first surface of said base sheet; and a repositionable adhesive disposed on said second surface of said base sheet; and
a printer in communication with said central processing unit, said printer capable of printing at least a portion of said bit-mapped image on said imageable substrate.

18. The system of claim 17, wherein said photo handling software additionally manipulates said bit-mapped image and generates text.

19. The system of claim 17, wherein said photo handling software provides a template comprising a region that accept bit mapped image, a region that creates text, and a predetermined graphics region.

20. A method of making an imaged photo card comprising the steps of:
providing a digital image;
providing a central processing unit including photo handling software that receives a bit-mapped image and generates text;
providing a printer that is in communication with said central processing unit;
providing a repositionable photo card, said card comprising an imageable substrate comprising a base sheet having opposing first and second surfaces, an image receptive coating disposed on said first surface of said base sheet and a repositionable adhesive disposed on said second surface of said base sheet;
using said photo handling software to create a virtual image of said photo card, said virtual image comprising a text region and a photo region; and
printing said virtual image on said imageable substrate.

21. The method of claim 20 further comprising manipulating at least one of said photo region and said text region.

22. The method of claim 20, wherein said photo handling software template comprises a region that accepts a bit mapped image, a region that creates text, and a predetermined graphics region.

23. A kit for producing personalized photo card, said kit comprising:
a photo handling software application capable of receiving a bit mapped image;
a repositionable photo card comprising an imageable substrate comprising a base sheet having opposing first and second surfaces, an image receptive coating disposed on said first surface of said base sheet and a repositionable adhesive disposed on said second surface of said base sheet; and
envelopes for containing said repositionable photo card.
